(19) United States
(12) Patent Application Publication
(10) Pub. No.: US 2026/0070321 A1
(43) Pub. Date: Mar. 12, 2026

(54) LENS PROCESSING METHOD, LENS AND SMART GLASSES

(71) Applicant: GOERTEK INC., Weifang (CN)

(72) Inventors: Peng GAO, Weifang (CN); Yaocheng LIU, Weifang (CN); Pan WANG, Weifang (CN); Xiaochao SONG, Weifang (CN); Xiangdong LAN, Weifang (CN); Ziheng DING, Weifang (CN); Xiaoming ZHU, Weifang (CN); Hongyuan ZHANG, Weifang (CN)

(21) Appl. No.: 19/389,231

(22) Filed: Nov. 14, 2025

Related U.S. Application Data
(63) Continuation of application No. PCT/CN2024/136707, filed on Dec. 4, 2024.

(30) Foreign Application Priority Data
Mar. 29, 2024 (CN) 202410381862.7

(51) Int. Cl. B32B 37/12; B32B 7/06; B32B 7/12; B32B 27/36; B32B 37/18; B32B 37/26; G02B 27/01

(52) U.S. Cl. CPC B32B 37/12; B32B 7/06; B32B 7/12; B32B 27/36; B32B 37/182; B32B 37/26; G02B 27/0176; B32B 2037/268; B32B 2551/00; G02B 2027/0178

(57) ABSTRACT

A lens of a lens processing method includes at least a first main lens layer, a patch antenna, and a second main lens layer stacked together. One of the first main lens layer and second main lens layer is a waveguide sheet, and the other of the first main lens layer and second main lens layer is a protective sheet. The lens processing method includes: adhering a first side of the patch antenna to the first main lens layer; and adhering the second main lens layer to a second side of the patch antenna.

### CROSS-REFERENCE TO RELATED APPLICATIONS

The present application is a continuation application of International Application No. PCT/CN2024/136707, filed on Dec. 4, 2024, which claims priority to Chinese Patent Application No. 202410381862.7, filed on Mar. 29, 2024. The disclosures of the above-mentioned applications are incorporated herein by reference in their entireties.

### TECHNICAL FIELD

The present application relates to the technical field of smart glasses, and in particular to a lens processing method, a lens and smart glasses.

### BACKGROUND

With the development of smart wearable devices, various new electronic products are constantly being developed, and smart glasses are one of them. Smart glasses need to realize data transmission function and are generally provided with antennas to receive and send signals.

However, antennas of existing display devices are usually installed by providing a special mounting base or mounting bracket on the frame. Such antenna fixing structure is relatively complicated, increases the difficulty of installation, and leads to high cost.

### SUMMARY

The main purpose of the present application is to provide a lens processing method, aiming to reduce the complexity of assembling antennas.

To achieve the above-mentioned object, the present application proposes a lens processing method. The lens includes at least a first main lens layer, a patch antenna, and a second main lens layer stacked together, one of the first main lens layer and the second main lens layer is a waveguide sheet and the other is a protective sheet, and the lens processing method includes:
adhering a first side of the patch antenna to the first main lens layer; and
adhering the second main lens layer to a second side of the patch antenna.

In an embodiment, the adhering the first side of the patch antenna to the first main lens layer includes:
tearing off a portion of a release paper provided at the first side of the patch antenna;
adhering a portion of the patch antenna, from which the release paper is tore off, to the first main lens layer; and
tearing off the remaining release paper provided at the first side of the patch antenna, and entirely adhering the first side of the patch antenna to the first main lens layer.

In an embodiment, in response to tearing off the portion of the release paper provided at the first side of the patch antenna, a ratio of the torn release paper to the whole release paper is ½ to ⅔.

In an embodiment, before the tearing off the remaining release paper provided at the first side of the patch antenna, the method further includes:
first discharging bubbles between the patch antenna adhered to the first main lens layer and the first main lens layer.

In an embodiment, after the entirely adhering the first side of the patch antenna to the first main lens layer, the method further includes:
discharging all bubbles between the patch antenna and the first main lens layer.

In an embodiment, after the discharging all bubbles between the patch antenna and the first main lens layer, the method further includes:
pressing the patch antenna to maintain pressure between the patch antenna and the first main lens layer.

In an embodiment, in response to that the patch antenna comprises an antenna body and a polyethylene terephthalate (PET) film for attaching the antenna body, and the antenna body is provided within the PET film, before the adhering the second main lens layer to the second side of the patch antenna, the method further comprises: first adhering a double-sided tape to the second side of the patch antenna, and adhering the second main lens layer to the second side of the patch antenna by the double-sided tape; or
in response to that the patch antenna comprises an antenna body adhered to the release paper, and the patch antenna is entirely adhered to the first main lens layer, before the adhering the second main lens layer to the second side of the patch antenna, the method further comprises: first adhering a double-sided tape to the first main lens layer, and adhering the second main lens layer to the first main lens layer through the double-sided tape to form an antenna gap between the double-sided tape, the first main lens layer and the second main lens layer, wherein the antenna body is provided in the antenna gap.

In an embodiment, before the tearing off the portion of the release paper provided at the first side of the patch antenna, the method further includes:
first positioning the first main lens layer at a positioning fixture.

The present application also provides a lens processed by the above-mentioned lens processing method.

The present application also provides smart glasses including the above-mentioned lens.

The above lens processing method has at least the following beneficial effects:

The technical solution of the present application is to adhere the first side of the patch antenna to the first main lens layer and attach the second main lens layer to the second side of the patch antenna. Specifically, in the related art, the antenna is typically located outside the lens, on the housing of the smart glasses. The patch antenna of the present application is transparent and sheet-like, positioned between the first main lens layer and second main lens layer. This allows the first main lens layer and second main lens layer to protect the patch antenna from both sides, effectively protecting it from damage. Furthermore, positioning the patch antenna between the first main lens layer and second main lens layer prevents the antenna from occupying space within the housing, thereby conserving space and making the smart glasses more compact. By adhering the first side of the patch antenna to the first main lens layer and then adhering the second main lens layer to the second side of the patch antenna, this layered assembly method simplifies assembly, reduces patch antenna assembly complexity, improves the yield rate of the lenses produced, and ultimately reduces the production cost of the lenses, ultimately reducing the production cost of the smart glasses.

### BRIEF DESCRIPTION OF THE DRAWINGS

In order to more clearly illustrate the embodiments of the present application or the technical solutions in the related art, the following briefly introduces the drawings required for use in the description of the embodiments or the prior art. Obviously, the drawings described below are only some embodiments of the present application. For those skilled in the art, other drawings can be obtained based on the structures shown in these drawings without paying any creative efforts.

FIG. 1 is a schematic partial structure diagram of smart glasses according to an embodiment of the present application.

FIG. 2 is a schematic structural diagram of the electrical connection position of a patch antenna of the smart glasses in FIG. 1.

FIG. 3 is a partial enlarged view of point A in FIG. 2.

FIG. 4 is a schematic exploded structure diagram of a lens according to an embodiment of the present application.

FIG. 5 is a flow chart of the lens processing method of the present application.

FIG. 6 is a schematic structural diagram of step S1 of the lens processing method in FIG. 5.

FIG. 7 is a schematic structural diagram of step S2 of the lens processing method in FIG. 5.

FIG. 8 is a schematic structural diagram of step S4 of the lens processing method in FIG. 5.

FIG. 9 is a schematic structural diagram of step S7 of the lens processing method in FIG. 5.

FIG. 10 is a schematic structural diagram of step S9 of the lens processing method in FIG. 5.

FIG. 11 is a structural structural diagram of step S10 of the lens processing method in FIG. 5.

The purpose, features and advantages of the present application will be further described with reference to the accompanying drawings and in conjunction with the embodiments.

### DETAILED DESCRIPTION OF THE EMBODIMENTS

The following will clearly and completely describe the technical solutions in the embodiments of the present application in conjunction with the accompanying drawings. Obviously, the described embodiments are only part of the embodiments of the present application, not all of the embodiments. All other embodiments obtained by those skilled in the art based on the embodiments of the present application without making any creative efforts shall fall within the scope of protection of the present application.

It should be noted that all directional indications (such as up, down, left, right, front, back, etc.) in the embodiments of the present application are only used to explain the relative position relationship, movement status, etc. between the various components under a certain specific posture (as shown in the accompanying drawings). If the specific posture changes, the directional indication will also change accordingly.

In the present application, unless otherwise specified or limited, the terms “connection” and “fixation” should be understood in a broad sense. For example, “fixation” can mean fixed connection, detachable connection, or integration; mechanical connection or electrical connection; direct connection or indirect connection through an intermediate medium; internal communication between two elements or interaction between two elements, unless otherwise specified. Those skilled in the art will be able to understand the specific meanings of the above terms in the present application based on specific circumstances.

In addition, if there are descriptions involving “first”, “second”, etc. in the embodiments of the present application, the descriptions of “first”, “second”, etc. are only for descriptive purposes and cannot be understood as indicating or suggesting their relative importance or implicitly indicating the number of the indicated technical features. Therefore, the features defined as “first” and “second” may explicitly or implicitly include at least one of such features. In addition, the meaning of “and/or” appearing throughout the text includes three parallel schemes. Taking “A and/or B” as an example, it includes scheme A, or scheme B, or a scheme in which A and B are satisfied at the same time. In addition, the technical solutions between the various embodiments can be combined with each other, but it must be based on the ability of those skilled in the art to implement. When the combination of technical solutions is mutually contradictory or cannot be implemented, it should be deemed that such a combination of technical solutions does not exist and is not within the scope of protection of the present application.

The present application provides a lens processing method.

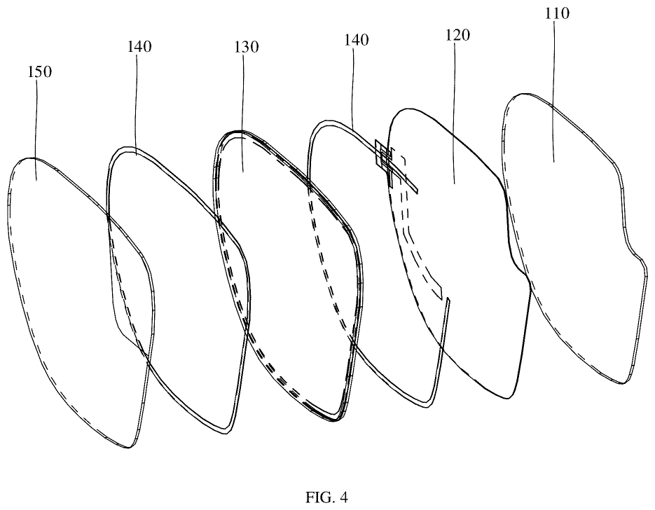

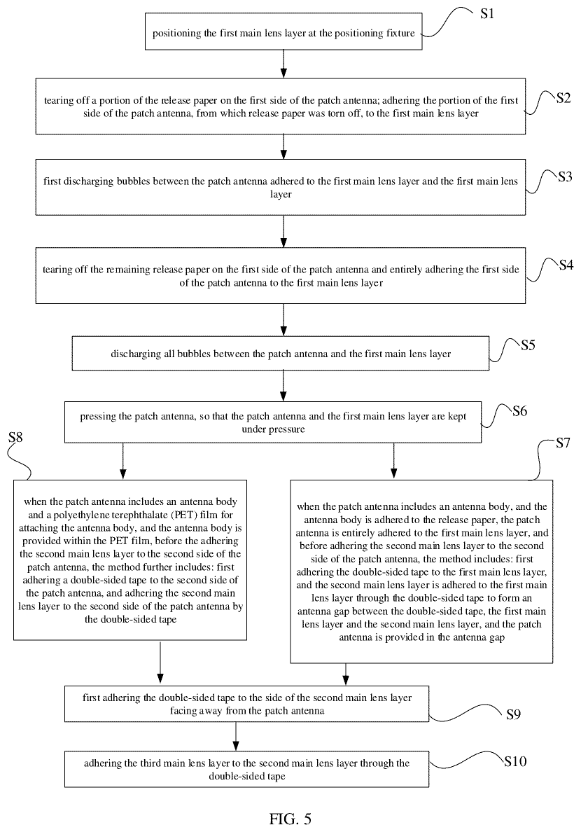

As shown in FIG. 4 and FIG. 5, in an embodiment of the present application, the lens 100 of the lens processing method includes at least a first main lens layer 110, a patch antenna 120, and a second main lens layer 130 stacked one on top of the other. One of the first main lens layer 110 and the second main lens layer 130 is a waveguide sheet, and the other is a protective sheet. The lens processing method includes the following steps: adhering the first side of the patch antenna 120 to the first main lens layer 110, and adhering the second main lens layer 130 to the second side of the patch antenna 120.

Specifically, in the related art, the antenna is typically located outside the lens 100, on the housing of the smart glasses. In the present application, the patch antenna 120 is a transparent sheet and is positioned between the first main lens layer 110 and the second main lens layer 130. This allows the first main lens layer 110 and the second main lens layer 130 to protect the patch antenna 120 from both sides, effectively protecting the patch antenna 120 from damage. Furthermore, positioning the patch antenna 120 between the first main lens layer 110 and the second main lens layer 130 prevents the antenna from occupying space within the housing, thereby saving space and making the smart glasses more compact.

The present application adheres the first side of the patch antenna 120 to the first main lens layer 110, and adheres the second main lens layer 130 to the second side of the patch antenna 120. This layer-by-layer lamination method simplifies assembly operations, helps reduce the complexity of assembling the patch antenna 120, improves the lamination yield of the lens 100, improves the yield rate of the produced lens 100, and thus reduces the production cost of the lens 100, ultimately achieving the effect of reducing the production cost of the smart glasses.

It should be noted that this embodiment takes the first main lens layer 110 as a protective sheet and the second main lens layer 130 as a waveguide sheet as an example. Of course, in some other embodiments, the first main lens layer 110 can also be a waveguide sheet and the second main lens layer 130 can also be a protective sheet.

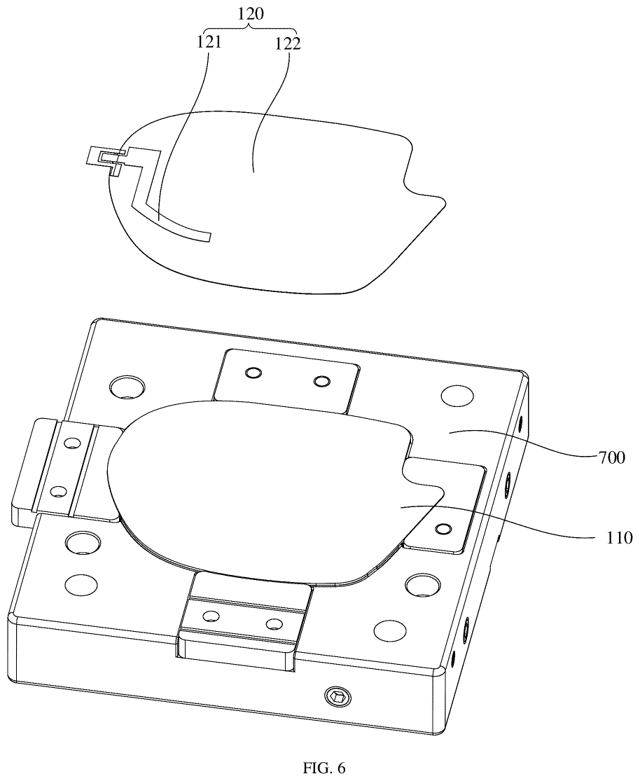

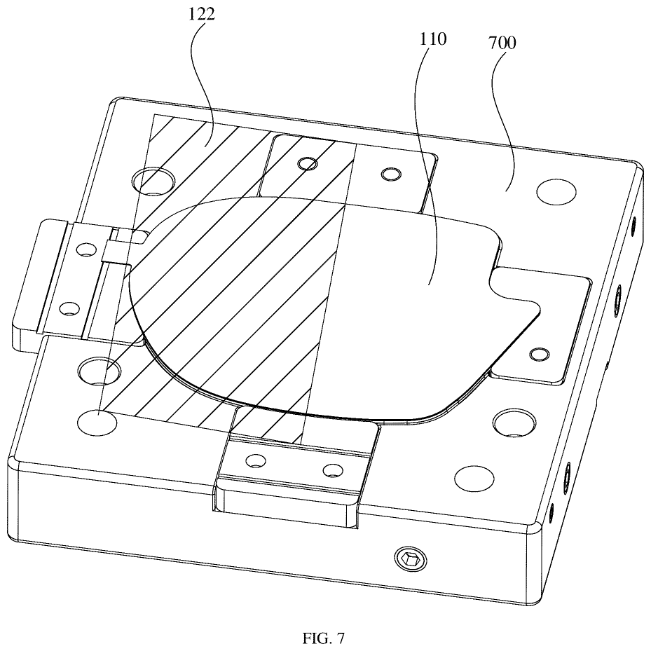

As shown in FIG. 6 to FIG. 8, a release paper 122 is provided on the first side of the patch antenna 120. It can be understood that the release paper 122 is a protective paper for the patch antenna 120. This can prevent dust from adhering to the surface of the patch antenna 120 and affecting the bonding effect between the first side of the patch antenna 120 and the first main lens layer 110. The release paper 122 can also protect the unbonded patch antenna 120.

The step of adhering the first side of the patch antenna 120 to the first main lens layer 110 includes: tearing off a portion of the release paper 122 on the first side of the patch antenna 120; adhering the portion of the first side of the patch antenna 120, from which release paper 122 was torn off, to the first main lens layer 110 (denoted as S2); and tearing off the remaining release paper 122 on the first side of the patch antenna 120 and entirely adhering the first side of the patch antenna 120 to the first main lens layer 110 (denoted as S4). This allows the patch antenna 120, after the release paper 122 is torn off, to be promptly adhered to the first main lens layer 110, thereby reducing the chance of dust in the air adhering to the first side of the patch antenna 120.

In an embodiment, when a portion of the release paper 122 on the patch antenna 120 is torn off, the proportion of the torn release paper 122 to the whole is in the range of ½ to ⅔. It can be understood that the smaller the length of the release paper 122 torn off, the closer it is to the patch antenna 120. The first time the release paper 122 is torn off, the proportion of the torn release paper 122 to the whole is in the range of ½ to ⅔. In this way, the release paper 122 can be relatively far away from the patch antenna 120, reducing the interference of the torn release paper 122 on the adhering of the patch antenna 120 and the first main lens layer 110, thereby improving the bonding efficiency.

Furthermore, before tearing off the remaining release paper 122, the method further includes: first discharging bubbles between the patch antenna 120 adhered to the first main lens layer 110 and the first main lens layer 110 (denoted as S3). It can be understood that the bubbles between the patch antenna 120 that has been adhered to the first main lens layer 110 and the first main lens layer 110 are first discharged because the bonding area is smaller. The bubble removal distance at this time is shorter than the bubble removal distance after the patch antenna 120 is entirely adhered to the first main lens layer 110. It can be seen that before tearing off the remaining release paper 122, the bubbles between the patch antenna 120 that has been adhered to the first main lens layer 110 and the first main lens layer 110 are first discharged, which is more convenient for discharging bubbles.

It should be noted that the bubble removal distance is the distance between the bubble and the edge of the bonding surface between the patch antenna 120 and the first main lens layer 110.

Furthermore, after entirely adhering the patch antenna 120 to the first main lens layer 110, the method further includes: discharging all bubbles between the patch antenna 120 and the first main lens layer 110 (denoted as S5). Similarly, this makes it easier to discharge the bubbles between the patch antenna 120 and the first main lens layer 110.

The purpose of discharging all bubbles between the patch antenna 120 and the first main lens layer 110 is to prevent the bubbles from affecting the clarity of the lens 100.

In an embodiment, after discharging all bubbles between the patch antenna 120 and the first main lens layer 110, the method further includes: pressing the patch antenna 120 (denoted as S6), so that the patch antenna 120 and the first main lens layer 110 are kept under pressure, so as to ensure the clarity between the patch antenna 120 and the first main lens layer 110.

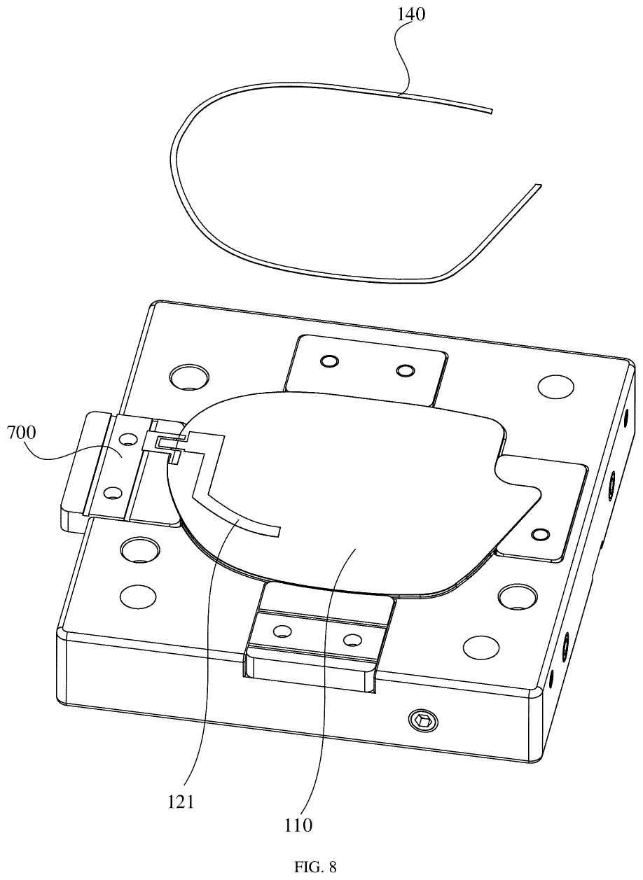

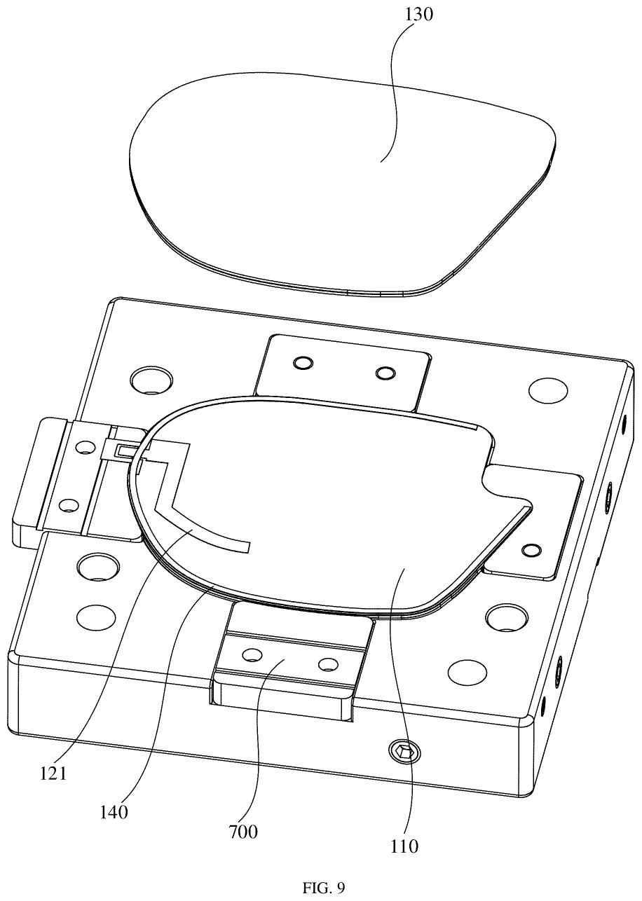

As shown in FIG. 8 and FIG. 9, in an embodiment, when the patch antenna 120 includes an antenna body 121 and a PET film to which the antenna body 121 is adhered, and the antenna body 121 is provided within the PET film, the shape of the PET film is the same as that of the first main lens layer 110, and release paper 122 is provided on both sides of the PET film.

At this time, before adhering the second main lens layer 130 to the second side of the patch antenna 120, the method further includes: first adhering the double-sided tape 140 to the second side of the patch antenna 120, and the second main lens layer 130 is adhered to the second side of the patch antenna 120 through the double-sided tape 140 (denoted as S8). This makes it easier to stack the layers and improves the stacking yield.

It should be noted that the PET film is transparent and colorless, and does not affect the optical properties of the lens 100. PET film also has high heat resistance and advantages such as allowing low-temperature reflow soldering. The antenna body 121 being provided within the PET film means that the surface of the antenna body 121 does not protrude from the surface of the PET film. It can be embedded within the PET film or entirely buried within the PET film.

In an embodiment, when the patch antenna 120 includes an antenna body 121, and the antenna body 121 is adhered to the release paper 122, the patch antenna 120 is entirely adhered to the first main lens layer 110, and before adhering the second main lens layer 130 to the second side of the patch antenna 120, the method includes: first adhering the double-sided tape 140 to the first main lens layer 110, and the second main lens layer 130 is adhered to the first main lens layer 110 through the double-sided tape 140 to form an antenna gap between the double-sided tape 140, the first main lens layer 110 and the second main lens layer 130, and the patch antenna 120 is provided in the antenna gap (denoted as S7). This makes it easier to stack the layers and improves the stacking yield.

This solution uses double-sided tape 140 for bonding. This is because double-sided tape 140 is convenient and easy to use. Double-sided tape 140 is a very convenient and easy-to-use glue that can be used without additional tools and equipment. It only needs to tear off the protective paper on the back and stick the glue on the first main lens layer 110 and the second main lens layer 130, or the second main lens layer 130 and the patch antenna 120 that need to be adhered. Compared with traditional glue and tape, double-sided tape 140 is simpler and faster to use, eliminating many useless steps and making bonding more convenient. Secondly, the double-sided tape 140 has good viscosity and can work at any temperature and humidity. Therefore, no matter what environment it is used in, it can maintain stable adhesion. Therefore, using double-sided tape 140 can improve the bonding stability of the first main lens layer 110 and the second main lens layer 130, and the second main lens layer 130 and the patch antenna 120. Furthermore, using the double-sided tape 140 can greatly save time, because it is very convenient to use, there is no need to wait for the glue to dry, and there is no need to wait for multiple parts to be adhered, so a lot of time can be saved.

As shown in FIG. 6, in an embodiment, before tearing off a portion of the release paper 122 on the patch antenna 120, the method further includes: first positioning the first main lens layer 110 at the positioning fixture 700 (denoted as S1). It can be understood that this solution increases the stability of the position of the first main lens layer 110 by positioning the first main lens layer 110 at the positioning fixture 700, thereby avoiding displacement of the first main lens layer 110 during the stacking process, thereby reducing the fit between the patch antenna 120 and the first main lens layer 110, improving the yield rate of the lens 100, and thus reducing the production cost of the smart glasses.

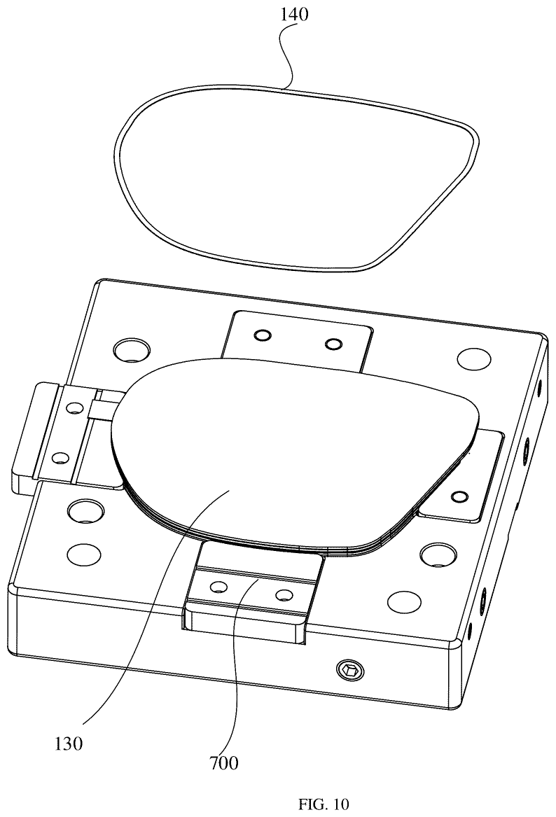

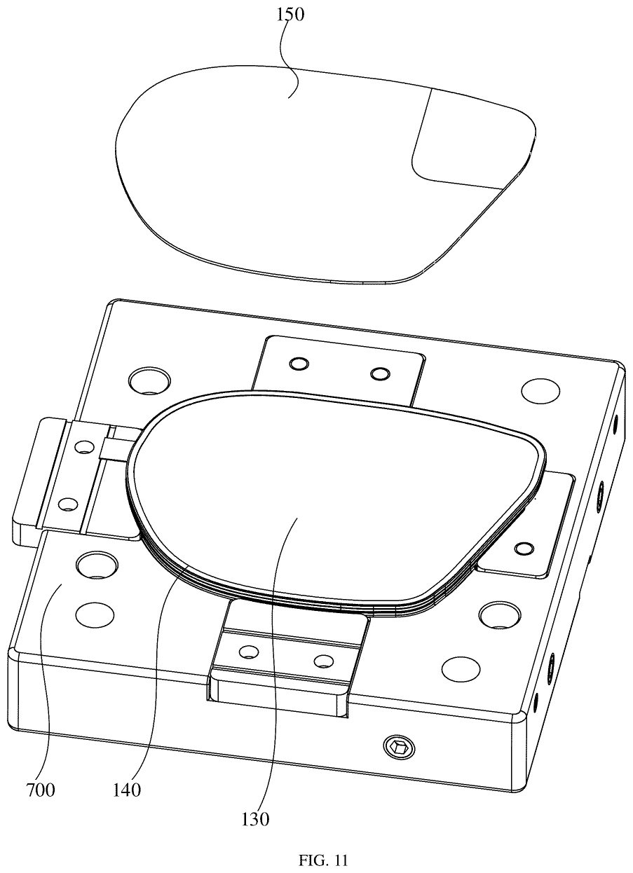

As shown in FIG. 10 and FIG. 11, the lens 100 further includes a third main lens layer 150. After the second main lens layer 130 is adhered to the second side of the patch antenna 120, the third main lens layer 150 is adhered to the side of the second main lens layer 130 facing away from the patch antenna 120.

Before adhering the third main lens layer 150 to the side of the second main lens layer 130 facing away from the patch antenna 120, the method includes: first adhering the double-sided tape 140 to the side of the second main lens layer 130 facing away from the patch antenna 120 (denoted as S9), and adhering the third main lens layer 150 to the second main lens layer 130 through the double-sided tape 140 (denoted as S10).

It can be understood that the third main lens layer 150 can better protect the waveguide sheet and the patch antenna 120, thereby being beneficial to improving the service life of the lens 100.

Furthermore, the third main lens layer 150 is adhered to the side of the second main lens layer 130 facing away from the patch antenna 120 through double-sided tape 140. This is because double-sided tape 140 is convenient and easy to use. Double-sided tape 140 is a very convenient and easy-to-use glue that can be used without additional tools and equipment. It only needs to tear off the protective paper on the back and stick the glue on the third main lens layer 150 and the second main lens layer 130 that need to be adhered. Compared with traditional glue and tape, double-sided tape 140 is simpler and faster to use, eliminating many useless steps and making bonding more convenient. Secondly, the double-sided tape 140 has good viscosity and can work at any temperature and humidity. Therefore, no matter what environment it is used in, it can maintain stable adhesion. Therefore, using double-sided tape 140 can improve the bonding stability of the third main lens layer 150 and the second main lens layer 130. Furthermore, using the double-sided tape 140 can greatly save time, because it is very convenient to use, there is no need to wait for the glue to dry, and there is no need to wait for multiple parts to be adhered, so a lot of time can be saved.

Specifically, the first main lens layer 110 and the third main lens layer 150 are both configured as protective sheets, and the second main lens layer 130 is a waveguide sheet. The first main lens layer 110 can be an inner protective sheet close to the human eye or an outer protective sheet away from the human eye. In this embodiment, the first main lens layer 110 is the inner protective sheet close to the human eye.

The present application further provides a lens manufactured using the above-described lens processing method. The specific structure of this lens is similar to the above-described embodiments. Since this lens utilizes all the technical solutions of all of the above-described embodiments, it possesses at least all the beneficial effects of the technical solutions of the above-described embodiments, and therefore will not be further elaborated here.

The present application also proposes smart glasses, which include lenses. The specific structure of the smart glasses refers to the above embodiment s. Since the lenses adopt all the technical solutions of all the above embodiments, they at least have all the beneficial effects brought by the technical solutions of the above embodiments, which will not be described one by one here.

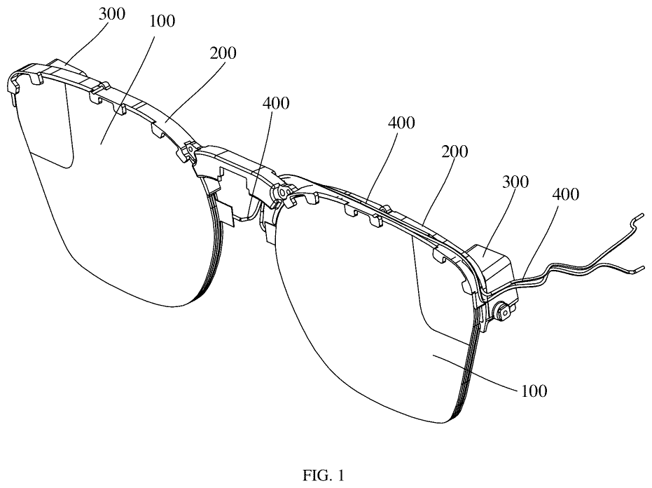

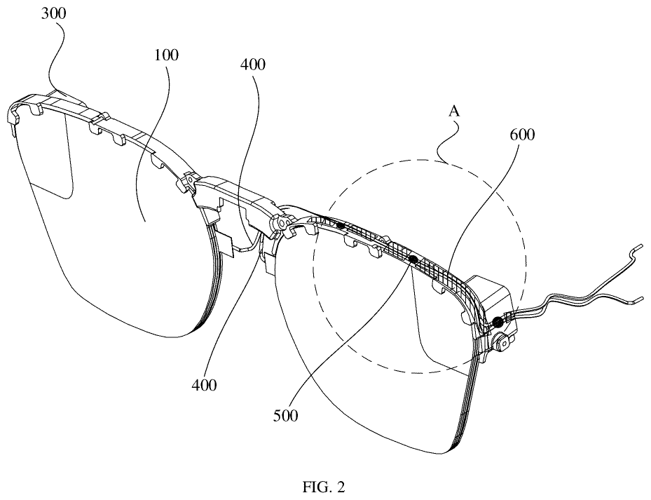

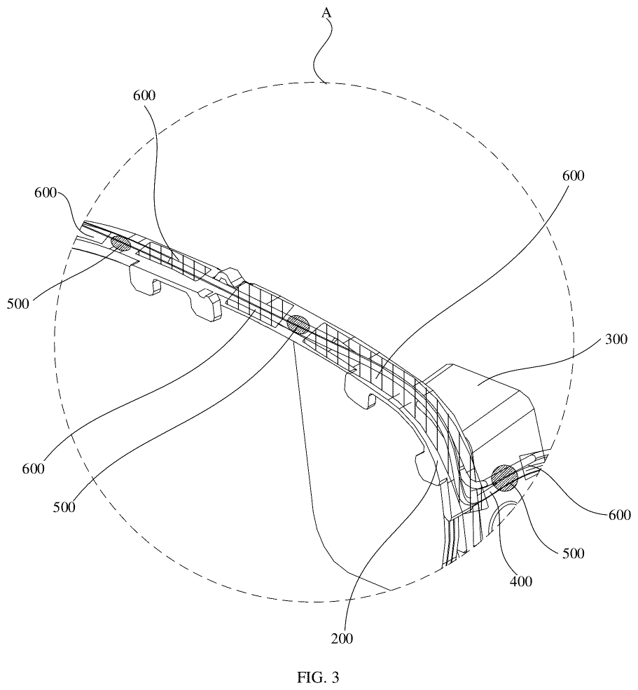

As shown in FIG. 1 to FIG. 3, the smart glasses include a support member 200, a lens 100 and an optical engine 300, and the lens 100 and the optical engine 300 are mounted on the support member 200. The patch antenna 120 of the lens 100 includes an antenna body 121 and a coaxial cable 400 electrically connected to the antenna body 121, and the coaxial cable 400 has a shielding layer. The support member 200 is conductive, the coaxial cable 400 is fixed to the support member 200, and the shielding layer is electrically connected to the support member 200 to achieve grounding of the patch antenna 120.

Smart glasses such as augmented reality (AR) glasses require built-in patch antennas 120 for receiving signals such as Wi-Fi and Bluetooth. Coaxial cable 400 feeding is a common feeding method for patch antenna 120. However, the electrical length of the longer coaxial cable 400 is comparable to the operating wavelength of the patch antenna 120, and significant surface current distribution exists on its shielding layer, thereby affecting the impedance matching and performance consistency of the patch antenna 120. This solution electrically connects the shielding layer of the coaxial cable 400 to the conductive support member 200, so that the support member 200 not only has its own supporting effect, but also can improve the surface current distribution of the shielding layer of the coaxial cable 400, improve the effect of the surface current on the impedance matching and performance consistency of the patch antenna 120, and improve the performance of the patch antenna 120. Therefore, this solution can save the additional grounding structure, thereby reducing the space occupied by the grounding structure, improving the space utilization of the smart glasses, and further improving the compactness of the smart glasses.

Furthermore, the coaxial cable 400 is also provided with an outer insulating layer covering the shielding layer, and when the coaxial cable 400 is peeled, a plurality of grounding positions are provided along the length direction of the coaxial cable 400 at intervals, exposing the shielding layer for electrical connection with the support member 200. It is understood that collisions are inevitable during use or transportation, and collisions can easily cause the grounding positions to become electrically disconnected from the support member 200, that is, the shielding layer and the support member 200 to become electrically disconnected. In this solution, the plurality of grounding positions are provided on the coaxial cable 400. Even if the electrical connection between a particular grounding position and the support member 200 is disconnected, the remaining grounding positions remain electrically connected to the support member 200. This ensures the stability of the electrical connection between the shielding layer and the support member 200, thereby improving the performance of the patch antenna 120.

In an embodiment, a protective layer is provided on the outer surface of the support member 200, and the support member 200 is provided with an electrical connection position corresponding to each grounding position. The protective layer is removed at the electrical connection position to electrically connect it with the shielding layer of the corresponding grounding position. It can be understood that by first removing the protective layer on the outer surface of the support member 200 and then electrically connecting the electrical connection position with the shielding layer of the corresponding grounding position, the influence of the protective layer on the electrical connection can be avoided, thereby increasing the stability of the grounding of the patch antenna 120.

The electrical connection position is configured as a laser-engraved position. Specifically, the laser-engraved position is where the protective layer on the outer surface of the support member 200 is removed through a laser engraving process. Laser engraving process offers high precision, accurately removing the protective layer at fixed locations, thereby reducing machining errors and improving the fit between the electrical connection positions and the grounding positions. Furthermore, the laser engraving process is fast and can form in one go, with low energy consumption. Therefore, the operating cost of the laser engraving process is low. Furthermore, the laser engraving process offers high processing efficiency, which can improve the production efficiency of smart glasses.

The electrical connection position is configured as a grinding position. Specifically, the grinding position refers to a position where a protective layer on the outer surface of the support member 200 is removed by a grinding process.

The protective layer may be a coating layer. When the support member 200 is a metal support member 200, the protective layer may also be an oxide layer.

In an embodiment, the electrical connection position and the grounding position are electrically connected through a conductive adhesive 500. This is because, firstly, the conductive adhesive 500 has good conductivity and can effectively conduct current, which can improve the conductivity between the shielding layer and the support member 200. Secondly, the conductive adhesive 500 can be easily processed into various forms. When the conductive adhesive 500 is used to conduct the shielding layer and the support member 200, the conductive adhesive 500 can adapt to the gap between the shielding layer and the support member 200 and form a specific form, thereby reducing the operational difficulty of conduction between the shielding layer and the support member 200. Thirdly, the conductive adhesive 500 has a long service life and will not reduce its conductivity and adhesion over time. Therefore, using the conductive adhesive 500 to conduct the support member 200 and the shielding layer can not only ensure the stability of the grounding of the shielding layer, but also increase the stability of the connection between the support member 200 and the shielding layer. Fourthly, the conductive adhesive 500 also has excellent plasticity and scalability, and can be coated, printed, sprayed, and other processing methods on substrates of different shapes and sizes formed between the shielding layer and the support member 200, reducing the difficulty of operation. Fifthly, the conductive adhesive 500 has excellent adhesion properties, so the conductive adhesive 500 can also increase the connection strength between the coaxial cable 400 and the support member 200. Sixthly, the conductive adhesive 500 has high stability. During the preparation process, the conductive adhesive 500 can control its conductive performance and stability by adjusting parameters such as the composition of the colloidal matrix and the concentration of the conductive particles. In this way, it can be formulated according to the current intensity of the shielding layer of the coaxial cable 400 of the smart glasses, which can better improve the surface current 's impact on the impedance matching and performance consistency of the patch antenna 120. Seventhly, the conductive adhesive 500 has a low cost, which can reduce the grounding cost of the smart glasses.

The conductive adhesive 500 can be silver powder conductive adhesive 500, carbon conductive adhesive 500, copper silver conductive adhesive 500, carbon nanotube conductive adhesive 500 water, silver paste conductive adhesive 500 water, conductive epoxy resin glue, nickel coated conductive adhesive 500 water or high viscosity conductive adhesive 500 water and other conductive adhesive 500, and no specific restrictions are made on the conductive adhesive 500 here.

In other embodiments, copper oxide paste may also be used to achieve grounding of the support member 200 and the shielding layer.

In an embodiment, the outer insulating layer of the coaxial cable 400 is adhered and fixed to the support member 200. This is because the bonding connection method is simple and can improve the connection efficiency between the coaxial cable 400 and the outer insulating layer.

Furthermore, the outer insulating layer of the coaxial cable 400 is adhered to the support member 200 by the structural adhesive 600. This is because the structural adhesive 600 has high strength, which can improve the connection strength between the outer insulating layer of the coaxial cable 400 and the support member 200, and reduce the probability of unstable connection between the outer insulating layer of the coaxial cable 400 and the support member 200, thereby affecting the grounding effect between the support member 200 and the shielding layer. Secondly, the structural adhesive 600 has a short curing time, which can greatly improve the connection efficiency between the outer insulating layer of the coaxial cable 400 and the support member 200, thereby improving the production efficiency of the smart glasses. Furthermore, the structural adhesive 600 is waterproof and shockproof, making the smart glasses more durable. The present application is not limited to this. In other embodiments, the outer insulating layer of the coaxial cable 400 can also be directly adhered to the support member 200 by the conductive adhesive 500.

In this embodiment, the outer insulating layer of the coaxial cable 400 is connected to the support member 200 through structural adhesive 600, and the shielding layer is electrically connected to the support member 200 through conductive adhesive 500, so as to achieve stable fixation and excellent grounding effect of the coaxial cable 400.

Furthermore, the structural adhesive 600 is configured as ultraviolet rays (UV) adhesive (shadowless adhesive, photosensitive adhesive or ultraviolet light curing adhesive). This is because UV adhesive can cure quickly, which can greatly improve the connection efficiency between the outer insulating layer of the coaxial cable 400 and the support member 200, thereby improving the production efficiency of the smart glasses. Secondly, the UV adhesive has strong adhesion, which can improve the connection strength between the outer insulating layer of the coaxial cable 400 and the support member 200, and reduce the probability of unstable connection between the outer insulating layer of the coaxial cable 400 and the support member 200, which affects the grounding effect between the support member 200 and the shielding layer. Moreover, the odor is small, which can reduce the odor of smart glasses and improve the comfort of users. Furthermore, the reliability of UV adhesive is high, which can improve the connection stability between the outer insulating layer of the coaxial cable 400 and the support member 200. The present application is not limited to this. In other embodiments, the structural adhesive 600 can also be configured as polyurethane reactive (PUR) structural adhesive 600 or polycarbonate (PC) structural adhesive 600.

In an embodiment, the coaxial cable 400 is provided with a plurality of bonding positions at intervals along its length direction, and the plurality of bonding positions and the plurality of connection positions are alternately arranged in sequence, which can increase the stability of the electrical connection between the grounding positions and the electrical connection positions.

In an embodiment, the support member 200 is the frame of the smart glasses or an independent component located in the frame. Specifically, this embodiment achieves grounding through the frame of the smart glasses or an independent component located in the frame. This can save an additional grounding structure, thereby reducing the space occupied by the grounding structure, improving the space utilization of the frame, and further improving the compactness of the frame.

Furthermore, in this embodiment, the support member 200 is made of a conductive metal. This is because conductive metal not only has excellent electrical conductivity but also possesses high strength and rigidity, which can improve current distribution on the surface of the shielding layer of the coaxial cable 400 while providing more stable support for the imaging device. The present application is not limited to this. In other embodiments, the support member 200 can also be made of a conductive non-metal, as long as it can achieve both electrical conductivity and support.

The above descriptions are merely some embodiments of the present application and do not limit the patent scope of the present application. All equivalent structural transformations made using the contents of the present specification and drawings under the inventive concept of the present application, or direct/indirect applications in other related technical fields, are included in the patent protection scope of the present application.

What is claimed is:

1. A lens processing method, wherein the lens comprises at least a first main lens layer, a patch antenna, and a second main lens layer stacked together, one of the first main lens layer and the second main lens layer is a waveguide sheet and the other of the first main lens layer and the second main lens layer is a protective sheet, and the lens processing method comprises:
adhering a first side of the patch antenna to the first main lens layer; and
adhering the second main lens layer to a second side of the patch antenna.

2. The lens processing method according to claim 1, wherein the adhering the first side of the patch antenna to the first main lens layer comprises:
tearing off a portion of a release paper provided at the first side of the patch antenna;
adhering a portion of the patch antenna, from which the release paper is tore off, to the first main lens layer; and
tearing off the remaining release paper provided at the first side of the patch antenna, and entirely adhering the first side of the patch antenna to the first main lens layer.

3. The lens processing method according to claim 2, wherein in response to the tearing off the portion of the release paper provided at the first side of the patch antenna, a ratio of the torn release paper to the whole release paper is ½ to ⅔.

4. The lens processing method according to claim 3, wherein before the tearing off the remaining release paper provided at the first side of the patch antenna, the method further comprises:
first discharging bubbles between the patch antenna adhered to the first main lens layer and the first main lens layer.

5. The lens processing method according to claim 2, wherein after the entirely adhering the first side of the patch antenna to the first main lens layer, the method further comprises:
discharging all bubbles between the patch antenna and the first main lens layer.

6. The lens processing method according to claim 5, wherein after the discharging all bubbles between the patch antenna and the first main lens layer, the method further comprises:
pressing the patch antenna to maintain pressure between the patch antenna and the first main lens layer.

7. The lens processing method according to claim 6, wherein:
in response to that the patch antenna comprises an antenna body and a polyethylene terephthalate (PET) film for attaching the antenna body, and the antenna body is provided within the PET film, before the adhering the second main lens layer to the second side of the patch antenna, the method further comprises:
first adhering a double-sided tape to the second side of the patch antenna, and adhering the second main lens layer to the second side of the patch antenna by the double-sided tape; or
in response to that the patch antenna comprises an antenna body adhered to the release paper, and the patch antenna is entirely adhered to the first main lens layer, before the adhering the second main lens layer to the second side of the patch antenna, the method further comprises:
first adhering a double-sided tape to the first main lens layer, and adhering the second main lens layer to the first main lens layer through the double-sided tape to form an antenna gap between the double-sided tape, the first main lens layer and the second main lens layer, wherein the antenna body is provided in the antenna gap.

8. The lens processing method according to claim 1, before the tearing off the portion of the release paper provided at the first side of the patch antenna, the method further comprises:
first positioning the first main lens layer at a positioning fixture.

9. A lens, processed by the lens processing method according to claim 1.

10. Smart glasses, comprising:
the lens according to claim 9.
